(19) United States
(12) Patent Application Publication
(10) Pub. No.: US 2025/0246360 A1
(43) Pub. Date: Jul. 31, 2025

(54) Terminal and Electromagnetic Coil

(71) Applicant: ZHEJIANG DUNAN ARTIFICIAL ENVIRONMENT CO., LTD., Shaoxing, Zhejiang (CN)

(72) Inventors: Wangping RU, Shaoxing, Zhejiang (CN); Bin WEI, Shaoxing, Zhejiang (CN); Changjun XIAO, Shaoxing, Zhejiang (CN)

(21) Appl. No.: 18/854,056

(22) PCT Filed: Mar. 31, 2023
(86) PCT No.: PCT/CN2023/085684

§ 371 Date: Oct. 3, 2024

(30) Foreign Application Priority Data
Apr. 7, 2022 (CN) 202220796824.4

(51) Int. Cl. H01F 27/29

(52) U.S. Cl. CPC H01F 27/29

(57) ABSTRACT

Some embodiments of the disclosure provide a terminal and an electromagnetic coil, the terminal including: an insertion portion, the insertion portion being provided with an insertion cavity for allowing a tab to be inserted therein; and a winding body, the winding body being connected to the insertion portion, and the winding body being provided with a winding portion for allowing a wire body to be wound thereon.

The disclosure is a national stage application of International Patent Application No. PCT/CN2023/085684, which is filed on Mar. 31, 2023, and claims priority on the basis of patent application No. 202220796824.4, filed with the National Intellectual Property Administration, PRC on Apr. 7, 2022 and entitled “Terminal and Electromagnetic Coil”.

### TECHNICAL FIELD

The present disclosure relates to the field of electromagnetic coils, and in particular to a terminal and an electromagnetic coil.

### BACKGROUND

In the field of electromagnetic coil devices, an electromagnetic coil needs to be supported by a mechanical structure to realize a corresponding electromagnetic function, and needs to be energized to perform conversion between electricity and magnetism, and thus an electromagnetic coil device needs to use a corresponding electrical connection structure.

In the related art, a tin soldering process can be used to connect an enameled wire with left and right tabs. However, since tin cannot be directly applied onto tabs using a tin soldering process, the enameled wire and the left and right tabs cannot be directly electrically connected by means of tin soldering.

### SUMMARY

The main object of some embodiments of the present disclosure is to provide a terminal and an electromagnetic coil, for solving the problem in the related art that an enameled wire and left and right tabs cannot be directly electrically connected by means of tin soldering.

In order to achieve the described object, according to one aspect of some embodiments of the present disclosure, provided is a terminal, including: an insertion portion, the insertion portion being provided with an insertion cavity for allowing a tab to be inserted therein; and a winding body, the winding body being connected with the insertion portion, the winding body being provided with a winding portion for allowing a wire body to be wound thereon.

In some embodiments, the insertion portion includes two mounting plates disposed opposite each other, the insertion cavity is formed between the two mounting plates, and outer side walls of the two mounting plates are configured to be in interference fit with tab mounting holes of a framework structure of the electromagnetic coil; or the winding body is plate-shaped, and a protruding portion is provided on a plate surface of the winding portion, so as to cause the wire body wound on the winding portion to be in contact with the protruding portion; or the insertion portion includes two mounting plates disposed opposite each other, the insertion cavity is formed between the two mounting plates, and outer side walls of the two mounting plates are configured to be in interference fit with tab mounting holes of a framework structure of the electromagnetic coil, and the winding body is plate-shaped, and a protruding portion is provided on a plate surface of the winding portion, so as to cause the wire body wound on the winding portion to be in contact with the protruding portion.

In some embodiments, each of the two mounting plates includes a first mounting section and a second mounting section which are sequentially connected in a insertion direction of the tab, at least a part of the second mounting section protrudes relative to the first mounting section towards a side close to the insertion cavity, and an outer side wall of the second mounting section is configured to be in interference fit with a corresponding tab mounting hole.

In some embodiments, an end of the second mounting section far away from the first mounting section is provided with a protruding section, and in the insertion direction of the tab, a free end of the protruding section extends towards a side far away from the insertion cavity.

In some embodiments, a wall surface of a side of each of the two first mounting sections close to the insertion cavity is provided with a snap-fit protrusion, and the two first mounting sections, by means of snap-fit protrusions, are in interference fit with two outer side walls of the tab spaced apart from each other in a thickness direction of the tab; or outer wall surfaces of two second mounting sections abut against an inner wall surfaces of the tab mounting holes; or a wall surface of a side of each of the two first mounting sections close to the insertion cavity is provided with a snap-fit protrusion, and the two first mounting sections, by means of snap-fit protrusions, are in interference fit with two outer side walls of the tab spaced apart from each other in a thickness direction of the tab, and outer wall surfaces of two second mounting sections abut against an inner wall surfaces of the tab mounting holes.

In some embodiments, the two first mounting sections are connected with the winding body, and both the two second mounting sections have a cantilever structure, such that the two second mounting sections can be deformably configured.

In some embodiments, the winding body has a Z-shaped structure formed by connecting three plate sections, and the insertion portion is connected with one plate section of the Z-shaped structure.

In some embodiments, the winding body includes an L-shaped plate section, the protruding portion has an L-shape, and the protruding portion extends along the L-shaped plate section.

According to another aspect of some embodiments of the present disclosure, provided is an electromagnetic coil, including: a framework structure; a wire body, the wire body being wound on the framework structure; and the tabs and the terminals, the framework structure being provided with tab mounting holes for allowing the tabs and the terminals to be inserted therein.

In some embodiments, the framework structure includes a first framework section, an outer periphery of the first framework section is provided with a first side wall surface and a second side wall surface, at least a part of the second side wall surface is a curved surface, the first side wall surface is a flat surface, and two ends of the first side wall surface are respectively connected with two ends of the second side wall surface; the tab mounting holes are provided on the first side wall surface, and when the tabs and the terminals are inserted into the tab mounting holes, the winding portions of the winding bodies of the terminals protrude out of a plane where the first side wall surface is located; the framework structure includes a lead-out groove, the lead-out groove is located on the second side wall surface, both ends of the lead-out groove is provided with a lead-out opening, and the wire body is led out from the lead-out openings and then wound on the winding portions.

By applying the technical solution of some embodiments of the present disclosure, the terminal of some embodiments of the present disclosure includes the insertion portion and the winding body, the insertion portion is provided with the insertion cavity for allowing the tab to be inserted therein, the winding body is connected to the insertion portion, and the winding body is provided with the winding portion for allowing the wire body to be wound thereon; and the winding body has a plate shape, and the protruding portion is provided on a plate surface of the winding portion, so as to cause the wire body wound on the winding portion to be in contact with the protruding portion. In this way, the wire body is wound on the protruding portion of the winding portion of the terminal, avoiding suspension of the wire body, increasing the contact area, and solving the problem in the related art that a terminal can negatively impact the winding quality of a wire body of an electromagnetic coil.

### BRIEF DESCRIPTION OF THE DRAWINGS

The drawings constituting a part of the description of the present disclosure are intended to provide better understanding of the present disclosure, and the schematic embodiments of the present disclosure and the description thereof are used to explain the present disclosure, but not to limit the present disclosure improperly. In the drawings:

FIG. 1 illustrates a structural schematic diagram of a first view of an embodiment of a terminal of the present disclosure;

FIG. 2 illustrates a structural schematic diagram of a second view of an embodiment of a terminal of the present disclosure;

FIG. 3 illustrates a structural schematic diagram of a third view of an embodiment of a terminal of the present disclosure;

FIG. 4 illustrates a structural schematic diagram of fitting between a tab and a terminal according to an embodiment of a terminal of the present disclosure;

FIG. 5 illustrates a whole structural schematic diagram of a framework structure according to an embodiment of an electromagnetic coil of the present disclosure;

FIG. 6 illustrates a structural schematic diagram of a first view of a wire body being wound on terminals according to an embodiment of an electromagnetic coil of the present disclosure;

FIG. 7 illustrates a structural schematic diagram of a second view of a wire body being wound on terminals according to an embodiment of an electromagnetic coil of the present disclosure; and

FIG. 8 illustrates a side view of a wire body being wound on terminals according to an embodiment of an electromagnetic coil of the present disclosure.

The drawings contain the following reference signs:

1. insertion portion; 10. mounting plate; 11. first mounting section; 110. snap-fit protrusion; 12. second mounting section; 13. protruding section; 101. insertion cavity; 20. framework structure; 200. tab mounting hole; 201. first mounting hole section; 202. second mounting hole section; 21. first framework section; 22. second framework section; 23. third framework section; 210. first side wall surface; 211. second side wall surface; 220. lead-out groove; 221. lead-out opening; 100. tab; 30. winding body; 31. third mounting section; 32. connecting portion; 33. winding portion; 330. protruding portion; 300. wire body.

### DETAILED DESCRIPTION OF THE EMBODIMENTS

It should be noted that, without conflict, the embodiments and the features of embodiments of the present disclosure can be combined. The embodiments of the present disclosure are described in detail with reference to the drawings combined with the embodiments.

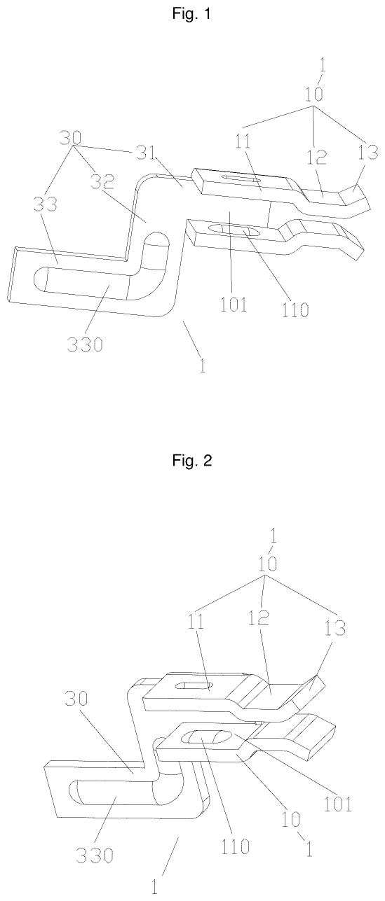

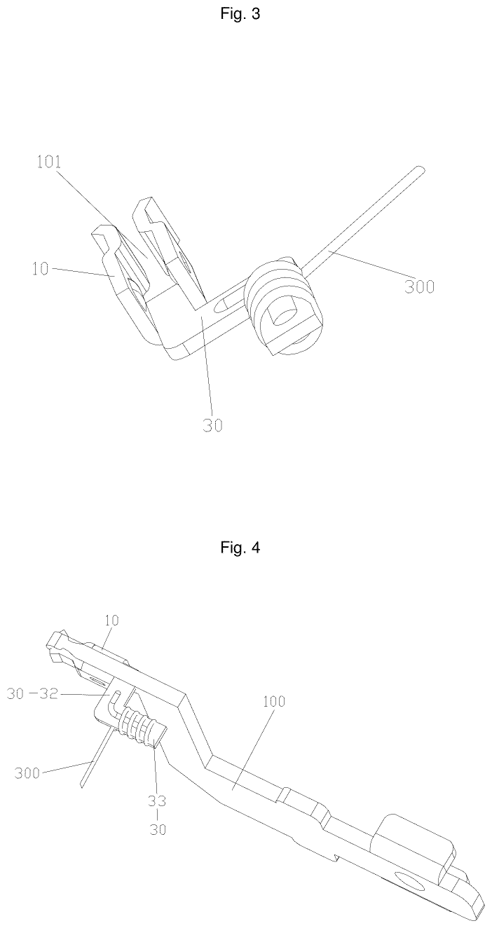

Referring to FIG. 1 to FIG. 4, some embodiments of the present disclosure provide a terminal, including: an insertion portion 1, the insertion portion 1 being provided with an insertion cavity 101 for allowing a tab 100 to be inserted therein; and a winding body 30, the winding body 30 being connected with the insertion portion 1, and the winding body 30 being provided with a winding portion 33 for allowing a wire body 300 to be wound thereon.

The terminal in some embodiments of the present disclosure includes the insertion portion 1 and the winding body 30, the insertion portion 1 is provided with the insertion cavity 101 for allowing the tab 100 to be inserted therein, the winding body 30 is connected to the insertion portion 1, and the winding body 30 is provided with the winding portion 33 for allowing the wire body 300 to wound thereon. In this way, the wire body is wound on the winding portion 33, the tab 100 is inserted in the insertion cavity 101, and by means of the insertion portion 1 and the winding body 30, an enameled wire and the tab 100 can be electrically connected using tin solder, solving the problem in the prior art that tabs and an enameled wire cannot be directly electrically connected by means of tin soldering.

The wire body 300 of some embodiments of the present disclosure is an enameled wire in an electromagnetic coil.

In some embodiments, the protruding surface of a protruding portion 330 is an arc-shaped surface.

In some embodiments, the insertion portion 1 includes two mounting plates 10 disposed opposite each other, the insertion cavity 101 is formed between the two mounting plates 10, and the outer side walls of the two mounting plates 10 are configured to be in interference fit with tab mounting holes 200 of a framework structure 20 of an electromagnetic coil. Or the winding body 30 is plate-shaped, and the protruding portion 330 is provided on a plate surface of the winding portion 33, so as to cause the wire body 300 wound on the winding portion 33 to be in contact with the protruding portion 330. Or the insertion portion 1 includes two mounting plates 10 disposed opposite each other, the insertion cavity 101 is formed between the two mounting plates 10, and the outer side walls of the two mounting plates 10 are configured to be in interference fit with tab mounting holes 200 of a framework structure 20 of an electromagnetic coil; and the winding body 30 is plate-shaped, and the protruding portion 330 is provided on a plate surface of the winding portion 33, so as to cause the wire body 300 wound on the winding portion 33 to be in contact with the protruding portion 330. In this way, the wire body 300 is wound on the protruding portion 330 of the winding portion 33 of the terminal, avoiding suspension of the wire body, increasing the contact area, and improving the winding quality of the wire body of the electromagnetic coil.

As shown in FIG. 1 to FIG. 3, each of the two mounting plates 10 includes a first mounting section 11 and a second mounting section 12 which are sequentially connected in the insertion direction of the tab 100, at least a part of the second mounting section 12 protrudes relative to the first mounting section 11 towards the side close to the insertion cavity 101, and the outer side wall of the second mounting section 12 is configured to be in interference fit with the corresponding tab mounting hole 200.

In some embodiments, there is a guide angle between the first mounting section 11 and the second mounting section 12.

In some embodiments, the end of the second mounting section 12 far away from the first mounting section 11 is provided with a protruding section 13, and in the insertion direction of the tab 100, a free end of the protruding section 13 extends towards the side far away from the insertion cavity 101.

In some embodiments, there is a guide angle between the protruding section 13 and the second mounting section 12.

In some embodiments, the wall surface of the side of each of the two first mounting sections 11 close to the insertion cavity 101 is provided with a snap-fit protrusion 110, and the two first mounting sections 11, by means of the snap-fit protrusions 110, are in interference fit with the two outer side walls of the tab 100 spaced apart from each other in the thickness direction of the tab 100. Or the outer wall surfaces of the two second mounting sections 12 abut against the inner wall surfaces of the tab mounting holes 200. Or the wall surface of the side of each of the two first mounting sections 11 close to the insertion cavity 101 is provided with a snap-fit protrusion 110, and the two first mounting sections 11, by means of the snap-fit protrusions 110, are in interference fit with the two outer side walls of the tab 100 spaced apart from each other in the thickness direction of the tab 100; the outer wall surfaces of the two second mounting sections 12 abut against the inner wall surfaces of the tab mounting holes 200.

In some embodiments, the free ends of the protruding sections 13 abut against the inner wall surfaces of the tab mounting holes 200.

In some embodiments, each snap-fit protrusion 110 protrudes towards the side close to the insertion cavity 101.

In some embodiments, the surface of each snap-fit protrusion 110 is an arc-shaped surface.

In some embodiments, the two first mounting sections 11 are connected with the winding body 30, and both the two second mounting sections 12 have a cantilever structure, such that the two second mounting sections 12 can be deformably configured.

In some embodiments of the present disclosure, the winding body 30 has a Z-shaped structure formed by connecting three plate sections, and the insertion portion 1 is connected with one plate section of the Z-shaped structure.

In some embodiments, the winding body 30 further includes a third mounting section 31 and a connecting portion 32, the winding portion 33 and the third mounting section 31 are configured to be parallel to each other, and the connecting portion 32 and the winding portion 33 or the third mounting section 31 are configured to be perpendicular to each other.

In some embodiments, the insertion portion 1 is connected with the third mounting section 31 of the winding body 30.

In some embodiments, the plate surface of the third mounting section 31 is in contact connection with one side wall surface, in the width direction of the mounting plate 10, of each mounting plate 10 of the insertion portion 1; or each of the side wall surfaces of the third mounting section 31 in the width direction thereof is in contact connection with the inner wall surface of each mounting plate 10 of the mounting portion 1 close to the insertion cavity 101.

In some embodiments, the winding body 30 includes an L-shaped plate section, the L-shaped plate section is formed by the connecting portion 32 and the winding portion 33, the protruding portion 330 has an L shape, and the protruding portion 330 extends along the L-shaped plate section.

In some embodiments, the terminal of some embodiments of the present disclosure is made of copper.

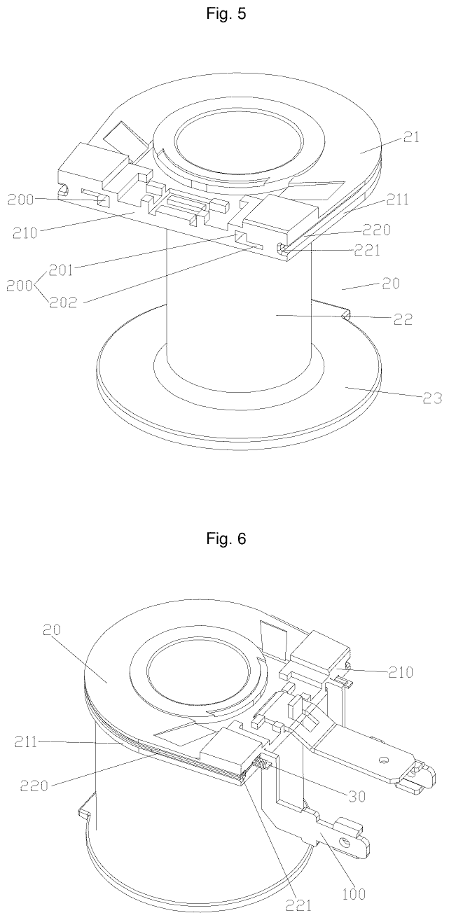

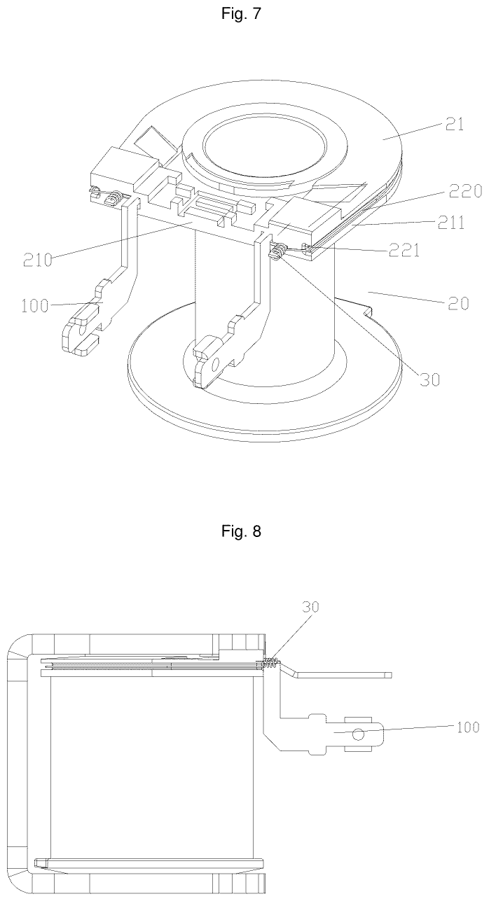

Referring to FIG. 5 to FIG. 8, some embodiments of the present disclosure also provide an electromagnetic coil, including: a framework structure 20; a wire body 300, the wire body 300 being wound on the framework structure 20; and the tabs 100 and the terminals, the framework structure 20 being provided with tab mounting holes 200 for allowing the tabs 100 and the terminals to be inserted therein.

In some embodiments, the wire body 300 is an enameled wire.

In some embodiments, the framework structure 20 includes a first framework section 21, the outer periphery of the first framework section 21 is provided with a first side wall surface 210 and a second side wall surface 211, at least a part of the second side wall surface 211 is a curved surface, the first side wall surface 210 is a flat surface, and two ends of the first side wall surface 210 are respectively connected with two ends of the second side wall surface 211; the tab mounting holes 200 are provided on the first side wall surface 210, and when the tabs 100 and the terminals are inserted in the tab mounting holes 200, the winding portions 33 of the winding bodies 30 of the terminals protrude out of the plane where the first side wall surface 210 is located; and the framework structure 20 includes a lead-out groove 220, the lead-out groove 220 is located on the second side wall surface 211, both ends of the lead-out groove 220 are provided with a lead-out opening 221, and the wire body 300 is led out from the lead-out openings 221 and then wound on the winding portions 33.

As shown in FIG. 5, the number of tab mounting holes 200 is two, the first side wall surface 210 has a stripe-shaped structure, and the two tab mounting holes 200 are respectively disposed at either end of the first side wall surface 210, so as to allow the winding portions 33 to be close to the lead-out openings 221, thereby avoiding suspension of the wire body 300 when the wire body is wound on the winding portions 33.

In some embodiments, each of the tab mounting holes 200 has an L-shaped structure, each of the tab mounting holes 200 includes a first mounting hole section 201 and a second mounting hole section 202, the first mounting hole section 201 is used for allowing the corresponding tab 100 to be inserted therein, and the second mounting hole section 202 is used for allowing the connecting portion 32 of the winding body 30 of the corresponding terminal to be inserted therein.

In some embodiments, the second mounting hole sections 202 of the two tab mounting holes 200 extend in opposite directions. Or the second mounting hole sections 202 of the two tab mounting holes 200 are respectively located at two ends of the first mounting hole sections 201. Or the second mounting hole sections 202 of the two tab mounting holes 200 extend in opposite directions, and the second mounting hole sections 202 of the two tab mounting holes 200 are respectively located at two ends of the first mounting hole sections 201.

In some embodiments of the present disclosure, the tabs 100 each has a Z-shaped structure, and can be directly plastic-encapsulated and led out and are connected with a junction box, without being connected with a junction box by means of connecting plates.

In some embodiments, the framework structure further includes a second framework section 22 and a third framework section 23, the first framework section 21, the second framework section 22, and the third framework section 23 jointly form an I-shaped structure, and the enameled wire is wound on the second framework section 22 and then led out by means of the lead-out groove 220 on the first framework section 21.

In the specific implementation process of some embodiments of the present disclosure, the enameled wire is wound on the framework structure 20 and is led out by means of the lead-out groove 220 of the framework structure 20, and is secured by the terminals, the terminals being made of copper; in this way, the enameled wire can be electrically connected with the tabs 100 by means of the terminals using a tin soldering process, and the tabs 100 of the electromagnetic coil are connected with the enameled wire by means of interference insertion fitting with the terminals, achieving the production using a tin soldering process.

From the description above, it can be determined that some embodiments of the present application achieve the following technical effects:

the terminal in some embodiments of the present disclosure includes the insertion portion 1 and the winding body 30, the insertion portion 1 is provided with the insertion cavity 101 for allowing the tab 100 to be connected therein, the winding body 30 is connected with the insertion portion 1, and the winding body 30 is provided with the winding portion 33 for allowing the wire body 300 to be wound thereon; and the winding body 30 has a plate shape, and the protrusion 330 is provided on a plate surface of the winding portion 33, so as to cause the wire body 300 wound on the winding portion 33 to be in contact with the protrusion 330. In this way, the wire body 300 is wound on the protruding portion 330 of the winding portion 33 of the terminal, avoiding suspension of the wire body, increasing the contact area, and solving the problem in the related art that a terminal can negatively impact the winding quality of a wire body of an electromagnetic coil.

The content above merely relates to preferred embodiments of the present disclosure and is not intended to limit the present disclosure. For a person skilled in the art, the present disclosure may have various modifications and variations. Any modifications, equivalent replacements, improvements, etc. made within the spirit and principle of the present disclosure shall all belong to the scope of protection of the present disclosure.

What is claimed is:

1. A terminal, comprising:
an insertion portion, the insertion portion being provided with an insertion cavity for allowing a tab to be inserted therein; and
a winding body, the winding body being connected with the insertion portion, and the winding body being provided with a winding portion for allowing a wire body to be wound thereon.

2. The terminal as claimed in claim 1, wherein
the insertion portion comprises two mounting plates disposed opposite each other, the insertion cavity is formed between the two mounting plates, and outer side walls of the two mounting plates are configured to be in interference fit with tab mounting holes of a framework structure of an electromagnetic coil; or
the winding body is plate-shaped, and a protruding portion is provided on a plate surface of the winding portion, so as to cause the wire body wound on the winding portion to be in contact with the protruding portion; or
the insertion portion comprises two mounting plates disposed opposite each other, the insertion cavity is formed between the two mounting plates, and outer side walls of the two mounting plates are configured to be in interference fit with tab mounting holes of a framework structure of an electromagnetic coil, and the winding body is plate-shaped, and a protruding portion is provided on a plate surface of the winding portion, so as to cause the wire body wound on the winding portion to be in contact with the protruding portion.

3. The terminal as claimed in claim 2, wherein
each of the two mounting plates comprises a first mounting section and a second mounting section which are sequentially connected in a insertion direction of the tab, at least a part of the second mounting section protrudes relative to the first mounting section towards a side close to the insertion cavity, and an outer side wall of the second mounting section is configured to be in interference fit with a corresponding tab mounting hole.

4. The terminal as claimed in claim 3, wherein
an end of the second mounting section far away from the first mounting section is provided with a protruding section, and in the insertion direction of the tab, a free end of the protruding section extends towards a side far away from the insertion cavity.

5. The terminal as claimed in claim 3, wherein
a wall surface of a side of each of two first mounting sections close to the insertion cavity is provided with a snap-fit protrusion, and the two first mounting sections, by means of snap-fit protrusions, are in interference fit with two outer side walls of the tab spaced apart from each other in a thickness direction of the tab; or
outer wall surfaces of two second mounting sections abut against an inner wall surfaces of the tab mounting holes; or
a wall surface of a side of each of two first mounting sections close to the insertion cavity is provided with a snap-fit protrusion, and the two first mounting sections, by means of snap-fit protrusions, are in interference fit with two outer side walls of the tab spaced apart from each other in a thickness direction of the tab, and outer wall surfaces of two second mounting sections abut against an inner wall surfaces of the tab mounting holes.

6. The terminal as claimed in claim 3, wherein
two first mounting sections are connected with the winding body, and both two second mounting sections have a cantilever structure, such that the two second mounting sections can be deformably configured.

7. The terminal as claimed in claim 1, wherein
the winding body has a Z-shaped structure formed by connecting three plate sections, and the insertion portion is connected with one plate section of the Z-shaped structure.

8. The terminal as claimed in claim 2, wherein
the winding body comprises an L-shaped plate section, the protruding portion has an L shape, and the protruding portion extends along the L-shaped plate section.

9. An electromagnetic coil, comprising:
a framework structure;
a wire body, the wire body being wound on the framework structure; and
tabs and the terminals as claimed in claim 1, the framework structure being provided with tab mounting holes for allowing the tabs and the terminals to be inserted therein.

10. The electromagnetic coil as claimed in claim 9, wherein
the framework structure comprises a first framework section, an outer periphery of the first framework section is provided with a first side wall surface and a second side wall surface, at least a part of the second side wall surface is a curved surface, the first side wall surface is a flat surface, and two ends of the first side wall surface are respectively connected with two ends of the second side wall surface;
the tab mounting holes are provided on the first side wall surface, and when the tabs and the terminals are inserted into the tab mounting holes, the winding portions of the winding bodies of the terminals protrude out of a plane where the first side wall surface is located; and
the framework structure comprises a lead-out groove, the lead-out groove is located on the second side wall surface, both ends of the lead-out groove are provided with a lead-out opening, and the wire body is led out from the lead-out openings and then wound on the winding portions.

11. The electromagnetic coil as claimed in claim 9, wherein
the insertion portion comprises two mounting plates disposed opposite each other, the insertion cavity is formed between the two mounting plates, and outer side walls of the two mounting plates are configured to be in interference fit with tab mounting holes of a framework structure of an electromagnetic coil; or
the winding body is plate-shaped, and a protruding portion is provided on a plate surface of the winding portion, so as to cause the wire body wound on the winding portion to be in contact with the protruding portion; or
the insertion portion comprises two mounting plates disposed opposite each other, the insertion cavity is formed between the two mounting plates, and outer side walls of the two mounting plates are configured to be in interference fit with tab mounting holes of a framework structure of an electromagnetic coil, and the winding body is plate-shaped, and a protruding portion is provided on a plate surface of the winding portion, so as to cause the wire body wound on the winding portion to be in contact with the protruding portion.

12. The electromagnetic coil as claimed in claim 11, wherein
the framework structure comprises a first framework section, an outer periphery of the first framework section is provided with a first side wall surface and a second side wall surface, at least a part of the second side wall surface is a curved surface, the first side wall surface is a flat surface, and two ends of the first side wall surface are respectively connected with two ends of the second side wall surface;
the tab mounting holes are provided on the first side wall surface, and when the tabs and the terminals are inserted into the tab mounting holes, the winding portions of the winding bodies of the terminals protrude out of a plane where the first side wall surface is located; and
the framework structure comprises a lead-out groove, the lead-out groove is located on the second side wall surface, both ends of the lead-out groove are provided with a lead-out opening, and the wire body is led out from the lead-out openings and then wound on the winding portions.

13. The electromagnetic coil as claimed in claim 11, wherein
each of the two mounting plates comprises a first mounting section and a second mounting section which are sequentially connected in a insertion direction of the tab, at least a part of the second mounting section protrudes relative to the first mounting section towards a side close to the insertion cavity, and an outer side wall of the second mounting section is configured to be in interference fit with a corresponding tab mounting hole.

14. The electromagnetic coil as claimed in claim 13, wherein
the framework structure comprises a first framework section, an outer periphery of the first framework section is provided with a first side wall surface and a second side wall surface, at least a part of the second side wall surface is a curved surface, the first side wall surface is a flat surface, and two ends of the first side wall surface are respectively connected with two ends of the second side wall surface;
the tab mounting holes are provided on the first side wall surface, and when the tabs and the terminals are inserted into the tab mounting holes, the winding portions of the winding bodies of the terminals protrude out of a plane where the first side wall surface is located; and
the framework structure comprises a lead-out groove, the lead-out groove is located on the second side wall surface, both ends of the lead-out groove are provided with a lead-out opening, and the wire body is led out from the lead-out openings and then wound on the winding portions.

15. The electromagnetic coil as claimed in claim 13, wherein
an end of the second mounting section far away from the first mounting section is provided with a protruding section, and in the insertion direction of the tab, a free end of the protruding section extends towards a side far away from the insertion cavity.

16. The electromagnetic coil as claimed in claim 15, wherein
the framework structure comprises a first framework section, an outer periphery of the first framework section is provided with a first side wall surface and a second side wall surface, at least a part of the second side wall surface is a curved surface, the first side wall surface is a flat surface, and two ends of the first side wall surface are respectively connected with two ends of the second side wall surface;
the tab mounting holes are provided on the first side wall surface, and when the tabs and the terminals are inserted into the tab mounting holes, the winding portions of the winding bodies of the terminals protrude out of a plane where the first side wall surface is located; and
the framework structure comprises a lead-out groove, the lead-out groove is located on the second side wall surface, both ends of the lead-out groove are provided with a lead-out opening, and the wire body is led out from the lead-out openings and then wound on the winding portions.

17. The electromagnetic coil as claimed in claim 13, wherein
a wall surface of a side of each of two first mounting sections close to the insertion cavity is provided with a snap-fit protrusion, and the two first mounting sections, by means of snap-fit protrusions, are in interference fit with two outer side walls of the tab spaced apart from each other in a thickness direction of the tab; or
outer wall surfaces of two second mounting sections abut against an inner wall surfaces of the tab mounting holes; or
a wall surface of a side of each of two first mounting sections close to the insertion cavity is provided with a snap-fit protrusion, and the two first mounting sections, by means of snap-fit protrusions, are in interference fit with two outer side walls of the tab spaced apart from each other in a thickness direction of the tab, and outer wall surfaces of two second mounting sections abut against an inner wall surfaces of the tab mounting holes.

18. The electromagnetic coil as claimed in claim 17, wherein
the framework structure comprises a first framework section, an outer periphery of the first framework section is provided with a first side wall surface and a second side wall surface, at least a part of the second side wall surface is a curved surface, the first side wall surface is a flat surface, and two ends of the first side wall surface are respectively connected with two ends of the second side wall surface;
the tab mounting holes are provided on the first side wall surface, and when the tabs and the terminals are inserted into the tab mounting holes, the winding portions of the winding bodies of the terminals protrude out of a plane where the first side wall surface is located; and
the framework structure comprises a lead-out groove, the lead-out groove is located on the second side wall surface, both ends of the lead-out groove are provided with a lead-out opening, and the wire body is led out from the lead-out openings and then wound on the winding portions.

19. The electromagnetic coil as claimed in claim 13, wherein
two first mounting sections are connected with the winding body, and both two second mounting sections have a cantilever structure, such that the two second mounting sections can be deformably configured.

20. The electromagnetic coil as claimed in claim 19, wherein
the framework structure comprises a first framework section, an outer periphery of the first framework section is provided with a first side wall surface and a second side wall surface, at least a part of the second side wall surface is a curved surface, the first side wall surface is a flat surface, and two ends of the first side wall surface are respectively connected with two ends of the second side wall surface;
the tab mounting holes are provided on the first side wall surface, and when the tabs and the terminals are inserted into the tab mounting holes, the winding portions of the winding bodies of the terminals protrude out of a plane where the first side wall surface is located; and
the framework structure comprises a lead-out groove, the lead-out groove is located on the second side wall surface, both ends of the lead-out groove are provided with a lead-out opening, and the wire body is led out from the lead-out openings and then wound on the winding portions.
